(19) United States
(12) Patent Application Publication
(10) Pub. No.: US 2005/0281932 A1
(43) Pub. Date: Dec. 22, 2005

(54) Frozen confection

(75) Inventors: Ramin Ghaffari, Green Bay, WI (US); Jon Richard Oldroyd, Green Bay, WI (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Good Humor - Breyers Ice Cream

(21) Appl. No.: 10/871,855

(22) Filed: Jun. 18, 2004

(51) Int. Cl. A23G 9/00

(52) U.S. Cl. 426/565

(57) ABSTRACT

A frozen confection containing one or more plant sterol and/or stanol and/or one or more esters thereof. The confection preferably includes milk solids and modest amounts of milk fat, whereby to provide a low fat frozen confection, e.g., a low fat ice cream, which gives the consumer valuable plant sterols or stanols, or their esters, while still affording good taste and mouthfeel.

### BACKGROUND OF THE INVENTION

Much debate has occurred in recent years concerning the causes of coronary disease in general and heart attacks in particular. The older model of a blood vessel clogged like a pipe is now being questioned, and a new image of soft plaques bursting and resulting in clot formation has begun to emerge. The influence of inflammation and C-reactive protein in vascular disease has also been gaining attention.

While there have been many changes in the understanding of coronary disease, cholesterol has long been, and remains, the focus of much concern. Whether coronary disease is viewed as progressing through the gradual clogging of a pipe or a sudden burst of plaques, cholesterol remains a chief suspect for its role in the formation of plaques. For some time, the ratio of HDL to LDL cholesterol has been seen as important in predicting the susceptibility of an individual to heart disease. More recently some have questioned the role of HDL cholesterol and focussed more on the LDL.

Several cholesterol lowering agents have been used in recent years. Prominent among these are the statin drugs. But use of these requires careful monitoring to avoid side effects. Another class of ingredients which has received attention for cholesterol lowering is the group of plant sterols, which have been suggested for lowering of LDL cholesterol levels. Plant sterols have been mentioned for use in foods both as sterols and as esters such as phytosterol fatty acid esters.

Phytosterol and phytostanol esters have been used commercially in spreads. Yet coronary heart disease remains a serious concern and it would be desirable to provide the consumer with additional opportunities for ingestion of significant amounts of these ingredients.

Frozen confections, such as ice cream, water ice, sherbet and the like, are popular as desserts and snacks. In view of their popularity and widespread use, these would be good candidates for providing consumers with additional opportunities for plant sterol/stanol ingestion. While many patentees have glibly included frozen confections among lists of foods in which plant sterols might be used, few examples of actual product formulations have been found in the patent literature to guide the product developer.

Gako-Golan, et al. WO 03/064444 is directed to a composition comprising at least one diacylglycerol and at least one phytosterol and/or phytostanol ester dissolved or dispersed in edible fat and/or oil, and further optionally comprising monoglycerides. The invention is also directed to their use as dietary nutrients, as food supplements and/or as ingredients in the food industry. The dietary nutrient or alimentary product according to the invention may be any of low cholesterol butter, cocoa butter, anhydrous milk fat, ice cream, coffee whitener and cream, dairy product, particularly cheese and other cholesterol-containing foods.

Gako-Golan, et al.'s edible oil is preferably selected from the group consisting of linseed oil, rapeseed oil, corn oil, olive oil, cocoa butter, rice brain oil, soybean oil, palm oil, palm kernal oil, castor oil, cottonseed oil, coconut oil, peanut oil, sunflower oil, avocado oil, safflower oil and fish oil. Gako-Golan, et al.'s edible fat is preferably selected from the group consisting of butterfat and animal fat, particularly lard.

Auriou WO 02/100412 is directed to a method of avoiding recrystallization of phytosterols from oil. The method involves use of a stabilizing combination of free fatty acids and phospholipids. The term “phytosterol” is used to encompass various compounds, including esters. The particle size distribution will usually be such that 90% of the particles are in the range of 100 nm to 35 um, more preferably 0.2 to 20 um. To influence blood cholesterol levels, a concentration of phytosterol in the finished product of between about 0.1% and 20% by weight and most preferably 5% to 8% by weight is aimed at.

Auriou's phytosterol-enriched oil can be used in conjunction with conventional food additives such as further stabilizing agents, e.g., emulsifiers, antioxidants, thickeners, salts, preservatives, flavoring agents, aromas, acidulants, food colors, etc. Among the many foodstuffs which it is said can be prepared using the dispersions of the invention are included dairy products such as cheese, ice cream, milk shakes, smoothies, yoghurt, and yoghurt drinks and formula diets. The product may be a low fat product, i.e., less than 5%, preferably less than 2% of total calories contributed by lipids. The food products may be supplemented with other health promoting ingredients, e.g., PUFA's, polyphenols, lipid-soluble antioxidants, eg, tocopherols, tocotrienols, lycopene, as well as amino acids, dietary fibers, vitamins, minerals water-soluble antioxidants, e.g., ascorbate and the like.

Oils, e.g., triglyceride oils which can be used in Auriou's invention are said to include sunflower, corn, rapeseed, peanut, grapeseed, olive, cottonseed, linseed, sesame seed, wheat germ, palm kernal, soybean, avocado, canola fish oils and other oils conventionally used in the food and pharmaceutical industries. Dairy fat, shortenings, and hdyrogenated, fractionated, and interesterified oils may also be employed.

Berry et al. U.S. 2002/0192318, U.S. 2001/0046548 and U.S. Pat. No. 6,277,431 are directed to an edible oil which is said to decrease the synthesis, absorption and blood level of cholesterol. The edible oil is prepared by adjusting the content of tocopherols, tocotrienols, free sterols, steryl esters and cycloartenols. Preferably the oils are vegetable oils, very preferably refined rice bran oils or mixtures of rice bran and palm oils. The edible oils can be incorporated into a variety of food products including without limitation butter, margarine, ice cream and mayonnaise, chocolate products, liquids such as soybean milk and rice milk, and water based drinks such as wines and mineral waters.

Yliruusi et al. U.S. Pat. No. 6,531,463 is directed to a method for producing a fatty blend in oil or fat of phytosterols in partially soluble or microcrystalline form said to be useful for lowering serum total- and LDL-cholesterol. Suitable foods to which the mixture can be added include cheese, sauces, dressings, pasta products and ice cream. It is said that any cooking or any food grade oil or fat, indeed any oil or oily compound of plant or animal origin, may be used.

Traska et al. U.S. Pat. No. 6,423,363 is directed to aqueous dispersions of plant sterols and other high melting lipids. Among the foods mentioned are ice cream. The dispersions may include water, salt, flavors, preservatives, gums, starches, gelatin, milk and milk protein, colors, acidulants such as citric acid and ingredients destined for the ultimate food product to be prepared from the dispersion. Where the food product includes a fat phase, preferably the fatty phase comprises one or more vegetable oils. Although not generally preferred, if desired dairy fat such as milk fat can be included. It is said that the use of fat compositions comprising a considerable amount of polyunsaturated fatty acid-rich triglycerides in addition to the use of the sterol/sterol-ester mixture is in particular considered highly beneficial. Spreads according to the invention can include microcrystalline cellulose.

Basheer et al. WO 01/75083 is directed to an enzymatic modification of sterols using sterol-specific lipase. It also concerns low cholesterol food preparations containing modified butterfat. The foods may be selected from the group which includes low cholesterol butter, cocoa butter, ice cream, coffee whiteners and creams, cheeses, other dairy products and other sterol-containing foods.

Hiramoto, et al. WO 03/041517 discloses a food deterioration preventive agent which contains a sterol as the active ingredient. The food may for instance be a drink, a frozen confection, a dessert, a fermented milk food, a dairy product, a confection or a fish paste. The sterols may come from plants. Among frozen confections mentioned are ice cream, sherbet and ice confections. Media which can be used to add and blend the food deterioration preventive agent include alcohols, medium chain fatty acid esters of glycerin or the like and purified vegetable oils such as coconut oil, corn salad oil and edible oils. Various additives such as thickeners and antioxidants may be present beforehand in the solution or dispersion.

Mankura et al. EP 1 275 309 is directed to foods containing sterol fatty acid ester compositions said to have pleasant texture, taste and flavor, wherein the free sterols are hardly crystallized during storage. The sterol fatty acid esters may be incorporated at levels of 1% by weight or more into foods having a low oil and fat content. The sterols have a degree of esterification of more than 90%. The degree of esterification is said to be the % of the weight of esterified sterols to the total amount of sterols (free and esters) and the esterified sterols in the oil phase including the sterol fatty acid ester composition.

Where the Mankura et al. sterol fatty acid ester composition is added to margarine, mayonnaise, dressing, ice cream and chocolate, the prevention of crystallization, saving of production costs, improvements in the flavor of foods and in physiological activity may be achieved. Also, the texture of mayonnaise, dressing and ice cream is said to be reformed and it is possible to provide a peculiar and fresh feeling in the mouth. An emulsifying effect is said to be obtained and the foods are said to display a favorable viscosity. The amount of thickeners and emulsion stabilizers may be decreased. Foods can also include edible oils such as canola, soybean and olive oils. Preferably, the proportion of unsaturated fatty acids of the sterol fatty acid esters is 88% or more. In example 9, a fat spread is prepared using hydrogenated rapeseed oil, cottonseed oil, whey and sterol esters.

Tamarkin WO 02/102169 is directed to an oil or fat composition comprising 15 wt % or more of synthetic fat and oil and 0.2 to 20 wt % of an edible solidifying agent in particular long chain fatty acids and/or long chain fatty alcohols. It is said to be used the same way as usual oil and fats in daily life to provide health benefits. In one embodiment, an anticholesteremic or anti lipidemic agent such as sterols or stanols, fatty acid esters and glycosides thereof, are included. Several possible food products are mentioned, including, ice cream, dressings, toppings, mayonnaise, peanut butters and margarines. Milk proteins are among proteins mentioned as emulsifiers.

Cain et al. U.S. 2002/0192353 discloses particulate systems of active solid organic components in a matrix with a mean weight diameter of 25 to 500 microns wherein the active organic component is selected from a group which includes phytosterols or derivatives or salts thereof. The matrix can be selected from a broad range of materials which includes polysaccharides, modified polysaccharides, sugars, gums, thickeners, stabilizers, syrups, flours, starches, maltodextrins and celluloses. Microcrystalline cellulose may be used. Preferred food products are selected from a group which includes margarine, spreads, baked goods, extruded goods, confections, ice creams and dairy products.

Auriou et al. WO 02/065859 discloses phytosterols dispersed at high concentrations in aqueous media by partial neutralization of their inherent w/o emulsifying properties using a non-sterol emulsifier having a higher HLB value. A preferred non-sterol emulsifier is a lecithin preparation comprising lysolecithin. The aqueous phytosterol dispersions can be used to prepare blood cholesterol lowering, stable w/o emulsions such as spreads, margarine, cheese, mayonnaise and ice cream. As emulsion stabilizers, gelling agents, fat replacers and thickeners, many examples are listed, including carrageenan, guar gum, gellan gum, locust bean gum, xanthan gum, cellulose gums, polydextrose, maltodextrin, cyclodextrins, cellulose and its methylated derivatives, microcrystalline cellulose, proteins or peptides such as whey based thickeners, finely divided solids such as clays, and silica. Vegetable fats are preferably used in Auriou et al.'s emulsified fat products, although dairy fats may also be used.

The '859 product can be supplemented with other health-promoting ingredients such as PUFA's, polyphenols, lipid soluble antioxidants (eg, tocopherol, tocotrienol, lycopene), water soluble antioxidants, amino acids, dietary fibers, vitamins, minerals and the like. In table 1, the dispersion includes phytosterol blend, unspecified thickener and milk protein. “Sterol” and “phytosterols” are used to encompass stanols and esters and derivatives.

Mellerup et al. WO 02/50221 is directed to a process for preparing vegetable oil fractions rich in non-tocolic, high melting unsaponifiable matter. The vegetable oil fraction can be used in dairy or dairy like food products selected from the group consisting of milk, cream, ice cream, butter, cheese, yoghurt and fermented milk products.

Schul et al. U.S. 2002/0016317 discloses sterol esters having fatty acid moieties comprising greater than 50% MUFAs. The sterol esters are said to have increased solubility. Food products to which the oils can be added include oils, shortening, peanut butter, mayonnaise, sauces, gravies, margarine, health bars, snacks, beverages, ice cream and yogurt.

Schersl U.S. Patent Application Publication No. U.S. 2002/0016314 discloses a composition for lowering LDL cholesterol comprising an ester of a phytosterol wherein the acid moiety is selected from the group consisting of eicosapentaenoic acid, docosapentaenoic acid, linoleic acid, linolenic acid and arachidonic acid. The esters can be incorporated into suitable food substances such as table margarine, shortening, ice cream, yogurt, and others.

Cain et al. U.S. Pat. No. 6,399,138 discloses concentrates of shea sterols which can be prepared by enzymic hydrolysis, and the application of the concentrates in aerated food products. Examples of aerated products include whippable creams, ice cream, and confectionary or bakery fillings. Shea sterols can be used with triglycerides such as soybean oil. In examples 6 and 7.4, ice cream is made using skim milk powder, shea sterols and a vegetable fat such as a mid palm fraction or a coconut oil.

WO 01/26668 is directed to compositions with anti prostate cancer activity. Phytosterols are optional ingredients. In addition to the anti-prostate composition, the invention can include another component, which is selected from the group of fats, partial glycerides, emulsifiers, food thickeners, SPE's, carbohydrates, proteins, water and fruit juice. Preferred foods include spreads, dressings, mayonnaise, creams, bakery products, snacks, ice cream, beverages, cereals and confectionery.

Kepplinger et al. U.S. Pat. No. 6,149,961 discloses a fat substitute comprising a shea nut extract. Among the foods mentioned in which it can be used is ice cream. Frozen desserts are disclosed. Example of diluent edible fats include soybean oil and bovine, porcine and fish sources. The fat substitute can be encapsulated using various food ingredients, including proteins. In example 6 is a frozen dessert including skim milk and the shea nut fat substitute.

Cargill's CoroWise Phytosterols product information brochure, available at least as early as Jun. 17, 2004, includes dairy products among products for which Cargill considers phytsterols to be GRAS.

Diks et al. WO 2004/014141 is directed to phytosterols, phytostanols, synthetic analogs thereof and their esterified derivatives as a creaminess enhancer in a food composition comprising a dairy product or derivative or analog thereof. Dairy products mentioned inlcude yoghurt, yoghurt drinks, yoghurt ice creams, creams (such as whipping cream, cooking cream, spoonable creams, pourable cream, coffee creamer), milk shakes, cream cheese, fresh cheese, creme fraiche, Kefir, Umer, quark, soured milk (karne milk), fromage frais, fromage blanc, cottage cheese, buttermilk and whey and products made from buttermilk or whey.

Jandacek U.S. Pat. No. 3,865,939 discloses edible cooking and salad oil compositions having enhanced hypocholesterolemic properties comprising plant sterol, a solubilizing agent such as free fatty acids, fatty acid esters, alkanols, and a clear liquid glyceride base oil. The solubilizing agents within the base are used at from about 0.5 to about 15 wt %. It is said that useful clear glyceride oils can be derived from vegetable and animal sources. Other contemplated foodstuffs include peanut butter, mayonnaise, ice cream, and margarine spreads which incorporate the oils.

### SUMMARY OF THE INVENTION

The present invention is directed to a frozen confection containing one or more plant sterol and/or stanol and/or one or more esters thereof. The confection preferably includes milk protein powder and modest amounts of fat, preferably milk fat, whereby to provide a reduced fat frozen confection, e.g., a reduced triglyceride ice cream, which provides the consumer with valuable plant sterols or stanols, or their esters, while still affording good taste and mouthfeel.

Preferably, the frozen confections of the invention employ sterols or stanols in the form of fatty acid esters to provide improved texture.

For a more complete of the above and other features and advantages of the invention, reference should be made to the following description of the preferred embodiment.

### DETAILED DESCRIPTION OF THE INVENTION

The product of the invention is a frozen product, such as ice cream, sherbet, water ice and the like. “Frozen,” as used herein, denotes that the product is solidified under freezing conditions to a hardpack or spoonable consistency which is not fluid or semi-fluid. The frozen confection may be combined with other ingredients such as wafers in an ice cream sandwich or an appropriate sauce in a sundae. Preferably any wafers, sauces or other adjuvants used in conjunction with the product have ingredients in line with the cholesterol lowering objectives of the frozen confection. The frozen confection is preferably a water-continuous emulsion.

Generally the product of the invention will include a dairy source, such as whole milk, skim milk, condensed milk, evaporated milk, cream, butter, butterfat, whey, milk solids non-fat, etc. The dairy source will generally contribute dairy fat and/or non-fat milk solids such as lactose and milk proteins, eg. whey proteins and caseins. In accordance with one aspect of the invention, a dairy protein powder, such as whey protein, is used as a protein source. Lactose will generally be present in the frozen confections of the invention within the range of from 0 to 8 wt %, especially from 0.5 to 7%, more preferably from 4 to 8 wt %. Dairy proteins will generally be present in the frozen confections of the invention at from 1 to 5 wt %, especially from 1 to 3 wt %. Other proteins may be present at from 0 to 3 wt %.

While butter fat from cream and other dairy sources is preferred, alternative fat sources, such as vegetable fat, may be used in some embodiments of the invention. For example, fats may be taken from the group which includes cocoa butter, illipe, shea, palm, palm kernal, sal, soybean, cottonseed, coconut, rapeseed, canola, and sunflower oils.

The level of triglyceride fat in the product, indeed preferably the total level of digestable lipid in the product, is preferably 5 wt. % or less, more preferably, 1.5 wt. % or less, especially 1.0 or even 0.5 wt. % or less. Lower limits for the triglcyeride fat or other lipids can be zero, 0.25 wt % 1 wt % or higher.

If desired, the product may include an emulsifying agent. Typical emulsifying agents may be phospholipids and proteins, such as dairy or soy proteins, or esters of long chain fatty acids and a polyhydric alcohol. Fatty acid esters of glycerol, polyglycerol esters of fatty acids, sorbitan esters of fatty acids and polyoxyethylene and polyoxypropylene esters of fatty acids may be used but organoleptic properties, or course, must be considered. Mono- and di-glycerides may also be used but may also be omitted. Indeed, emulsifiers other than proteins and phospholipids may be omitted. If present, non-protein emulsifiers are used in amounts of about 0.03% to 0.5%, preferably 0.1% to 0.2%.

Soybean protein isolates combined with modified food starches such as Ultrafreeze 400C® obtained from A.E. Staley Manufacturing Co. may assist in texturizing the product and, if present, are used in amounts of 0.5% to 8.0 wt %, preferably 3% to 6 wt %.

Gum stabilizers are particularly effective in controlling viscosity, providing mouth feel and improving whipping (aerating) properties; to provide a protective colloid to stabilize proteins to heat processing; to modify the surface chemistry of fat surfaces to minimize creaming; to provide acid stability to protein systems and; to increase freeze-thaw stability. Gums can be classified as neutral and acidic, straight- and branched-chain, gelling and non-gelling. The principal gums that may be used are Karaya gums, locust bean gum, carageenan, xanthan, guar and carboxymethyl cellulose.

Gums are generally used in concentrations of 0.02-0.5 wt. % of the composition. Because of differing functionalities, combinations of certain gums may provide a better product than a single gum. For instance, for some types of frozen confections karaya gum is ideally used together with polydextrose.

The stabilizer may be microcrystalline cellulose as described in U.S. Pat. No. 5,209,942, e.g., Avicel 581, which is activated or “peptized.” Microcrystalline cellulose is cellulose crystallite aggregates with a level-off D.P. Level off DP is the average level-off degree of polymerization measured in accordance with the paper by O. A. Batista entitled: “Hydrolysis and Crystallisation of Cellulose,” Vol. 42, pages 502 to 507, Industrial and Engineering Chemistry, 1950. An example of microcrystalline cellulose is the water-dispersible cellulose crystallite aggregates described for use in food compositions in British Patent No. 961 398 (Also cf. U.S. Pat. Nos. 2,978,446, 3,157,518 and 3,539,365). A combination of microcrystalline cellulose and sodium carboxymethyl cellulose (CMC) may give good results, and the microcrystalline cellulose is preferably a material in which the particles are themselves coated with 10 percent (by weight of the material) of sodium carboxymethyl cellulose. The sodium carboxymethyl cellulose used for coating is preferably one of medium viscosity, that is one which, in 1 percent aqueous dispersion, has a viscosity of from 300 to 1000 centipoises at 20° C.

Microcrystalline cellulose has been listed in the Fourth Supplement to the Food Chemicals Codes, First Edition, by the National Academy of Sciences-National research Council as: Cellulose, Microcrystalline (cellulose gel). Cellulose gel in combination with cellulose gum is especially preferred.

Another component may comprise one or any combination of carboxymethylcellulose (in addition to that with which the microcrystalline cellulose may be coated), xanthan gum, starch and alginate.

If desired, gelatin, e.g, 225 bloom, may be included in the compositions at levels of say 0.1-1 wt %, especially from 0.1-0.3 wt %. Certain salts such as phosphates and chlorides may be employed to alter the buffering capacity of the system and to improve the water binding capacity of proteins and improve solubility and flavor. Sodium chloride and sodium monophosphate at very low levels are preferred but calcium phosphate and particularly monocalcium phosphate may also be employed. Sodium chloride is preferred at levels of 0.05% to 0.3%; and sodium monophosphate is preferred at levels of 0.01% to 0.1%. The bulking agents employed must have only trace amounts of mono- and disaccharides.

Generally the compositions of the invention will be naturally sweetened. Natural sources of sweetness include sucrose (liquid or solids), glucose, fructose, and corn syrup (liquid or solids). Other sweeteners include lactose, maltose, and galactose. Levels of sugars and sugar sources preferably result in sugar solids levels of up to 20 wt %, preferably from 5 to 18 wt %, especially from 10 to 18 wt %.

If it is desired to use artificial sweeteners, any of the artificial sweeteners well known in the art may be used, such as aspartame, saccharine, Alitame® (obtainable from Pfizer), acesulfame K (obtainable from Hoechst), cyclamates, neotame, sucralose and the like. The sweeteners are used in varying amounts of about 0.005% to 1%, preferably 0.007% to 0.73% depending on the sweetener, for example. Aspartame may be used at a level of 0.01% to 0.15%, preferably at a level of 0.01% to 0.05%. Acesulfame K is preferred at a level of 0.01% to 0.15%.

If desired, the product may include polydextrose. Polydextrose functions both as a bulking agent and as a fiber source and is preferably included at from 1 to 10 wt %, especially from 3 to 6 wt %.

Polydextrose may be obtained under the brand name Litesse® from Danisco Sweeteners. Among other fiber sources which may be included in the compositions of the invention are fructose oligosaccharides such as inulin.

In accordance with the preferred use of inert polydextrose, as a bulking agent, additional conventional bulking agents may be used such as maltodextrin, sugar alcohols, corn syrup solids, sugars or starches. Total bulking agent levels in the products of the invention will preferably be from about 5% to 20%, preferably 13% to 16%.

If desired, sugar alcohols such as glycerol, sorbitol lactatol, maltitol, manitol, etc. may be used to control ice formation. If present, glycerol may be used in an amount of about 1% to 5%, preferably 2.5% to 4.0%. However, the present invention also contemplates formulations in which glycerol is excluded.

Flavorings are preferably added to the product but only in amounts that will impart a mild, pleasant flavor. The flavoring may be any of the commercial flavors employed in ice cream, such as varying types of cocoa, pure vanilla or artificial flavor, such as vanillin, ethyl vanillin, chocolate, extracts, spices and the like. It will further be appreciated that many flavor variations may be obtained by combinations of the basic flavors. The confection compositions are flavored to taste as mentioned above. Suitable flavorants may also include seasoning, such as salt, and imitation fruit or chocolate flavors either singly or in any suitable combination. Flavorings may also mask any off-tastes from vitamins and/or minerals and other ingredients.

Malt powder can be used, e.g., to impart flavor, preferably at levels of from 0.01 to 3.0 wt %, especially from 0.05 to 1%.

Preservatives such as Polysorbate 80, Polysorbate 65 and potassium sorbate may be used as desired.

Calcium may be present in the composition, for example, at from 10 to 30% RDI, especially about 25% RDI. The calcium source may be tricalcium phosphate. If so desired, the product may be fortified with one or more vitamins and/or minerals and/or fiber sources, in addition to the tricalcium phosphate source of calcium. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (as Manganese Sulfate), Iron (as Ferric Orthophosphate) and Zinc (as Zinc Oxide). The vitamins may be present, for example, at from 5 to 20% RDI, especially from about 15% RDI. Vitamin A addition may be desirable to replace vitamin A which is typically present in milk fat in ice cream.

Preferably, fiber sources are present in the product at greater than 0.5 wt % and do not exceed 6 wt %, especially 5 wt %.

The compositions of the invention preferably include little or no free fatty acid. For example, compositions may include less than 0.3 wt %, especially less than 0.2 wt %, most preferably less than 0.1 wt %, still more preferably essentially no free fatty acid, ie, no detectable free fatty acid. Likewise, the compositions of the invention preferably include little or no long hydrocarbon chain (e.g, up to 50 carbon atoms) fatty alcohols. For instance, compositions may include less than 0.3 wt %, especially less than 0.2 wt %, most preferably less than 0.1 wt %, still more preferably essentially no long chain fatty alcohol, ie, no detectable long chain fatty alcohol. Examples of long chain fatty alcohols include cetyl alcohol and stearyl alcohol.

Some of the vitamins and/or minerals can be added to the frozen confection mix whereas others can be included in ingredients for adjuncts such as wafers, variegates and sauces.

The term “phytosterols” herein encompasses plant sterols, esters of plant sterols, plant stanols and stanol esters, and stanols and stanol esters derivable from plant sterols. Examples include sitosterol, sitostanol, their fatty acid esters, and the like. These may be included in the compositions of the invention at various levels, such as from 1 to 5 wt %, especially from 1.5 to 2.5 wt % of the food product based on the sterol moiety.

More specifically, examples include alpha sitosterol, beta sitosterol, stigmasterol, ergosterol, campesterol, alpha sitostanol, beta sitostanol, campestanol and brassicasterol. Although the foregoing are some of the more important phytosterols, at least 44 phytosterols have been identified and it will be apparent to one of ordinary skill that many of these will be appropriate for the present invention. Oryzanol may also be used. Phytosterols are identified in Bean Phytosterols in 1993 “Advances in Lipid Research”, pages 193-218, Paoletti and Kiritchevsky (Eds), Academic Press, New York, the disclosure of which is incorporated by reference. The disclosure of “Effect of Plant Sterols on Lipids and Atherosclerosis,” Pollack, O. J., Pharmac, Ther. 31, 177-208 (1985) is also incorporated by reference herein.

Among the more important sources of phytosterols are rice bran, corn bran, corn germ, wheat germ oil, corn oil, safflower oil, oat oil, olive oil, cotton seed oil, soybean oil, e.g., soybean oil distillates, peanut oil, black tea, orange juice, valencia, green tea, Colocsia, kale, broccoli, sesame seeds, shea oils, grapeseed oil, rapeseed oil, linseed oil, canola oil, tall oil from wood pulp and other resinous oils from wood pulp.

Preferably the sterols/stanols/esters have not been enzyme modified; natural sterols and/or stanols, whether or not esterified, are preferred for the compositions of the invention.

Where stanol or sterol esters are used, the degree of esterification may, for example, be from 40 to 100%, preferably from 90-100, especially from 95-99%, on a molar basis. Preferably less than 3% free sterols on a molar basis are present.

The plant sterols of the present invention are those which have an appreciable cholesterol lowering effect in humans, either total serum cholesterol or serum LDL cholesterol, such as B-sitosterol, campesterol, and stigmasterol, but excludes compounds which do not have an appreciable cholesterol lowering effect such as alpha amyrin, which is sometimes characterized as a “phytosterol.”

Sterols and/or sterol esters are available from Cargill of Wayzata, Minn. under the CoroWise™ brand and from ADM of Decatur Ill.

Processes used for the manufacture of the product are essentially the same as for their typical dairy product counterparts. The processes common to all such products include: ingredient blending, pumping, pasteurization, homogenization, cooking, aeration, freezing and packaging. Products can be manufactured by batch or by continuous processes. Ingredients may be either liquid or dry, or a combination of both. Liquid ingredients can be blended by the use of positive metering pumps to a mixing tank or by in-line blending. Dry ingredients must be hydrated during the blending operations. This is most commonly accomplished by the use of turbine mixers in processing vats or by incorporating the dry material through a high speed, centrifugal pump. The blending temperature depends upon the nature of the ingredients, but it must be above the melting point of any fat and sufficient to fully hydrate any gums used as stabilizers and any proteins. If batch processing is used, optional vitamins and other minerals may be blended with cold water, mixed well and added to the batch after a portion of the mix has flowed to the HTST units. Pasteurization is generally carried out in high temperature short time (HTST) units, in which the homogenizer is integrated into the pasteurization system. Protein and any microcrystalline cellulose are advisedly fully hydrated before adding other components which might interfere with the hydration.

Preferably the product of the invention is not fermented. For instance, it does not include lactobaccillus bulgaricus or streptococcus thermophilus cultures. Likewise, it is preferably not yogurt-flavored.

Unless stated otherwise or required by context, the terms “fat” and “oil” are used interchangeably herein. Unless otherwise stated or required by context, percentages are by weight.

### EXAMPLE 1

Chocolate Flavored Low Fat Ice Cream Mix

A low fat ice cream mix with the following formula is prepared:

| Formula | % | Total solids |
|---|---|---|
| Milk fat | 0.27 | 0.27 |
| Milk solids nonfat | 9 | 9 |
| Whey powder | 2.5 | 2.4 |
| Liquid sucrose | 19.4 | 13 |
| Corn syrup (80% ts) | 5.6 | 4.5 |
| Polydextrose | 4.8 | 4.6 |
| Cocoa | 2.5 | 2.5 |
| Stabilizer Gum Emulsifier | | |
| Blend (ex Danisco) | 0.37 | 0.37 |
| Avicel (stabilizer) | 0.35 | 0.35 |
| Star Vite A | 0.003 | 0.003 |
| Steryl esters | 2.45 | 2.45 |
| Water | 52.7 | |

The procedure is as follows:

1. Draw water into liquifier. Water up to 100° F. should be used when utilizing the cold batching method for non-viscous mixes.

2. Blend liquid sucrose and corn syrup.

3. Add stabilizer blend slowly (10#/minute). Allow to blend until stabilizers are hydrated.

4. Add whey followed by polydextrose and cocoa.

5. Add milk source (fresh milk or condensed skim milk are preferred sources) to liquifier or blend tank to dilute mixture.

6. Add Star Vite A (vitamin A palmitate).

7. Add Steryl Esters. Then add Cream and agitate for 5 minutes before pasteurizing.

8. Pasteurize and homogenize at standard temperatures and pressures.

### EXAMPLE 2

Low Fat Ice Cream Mix

A low fat ice cream mix with the following formula is prepared:

| Formula | % | % total solids |
|---|---|---|
| Milkfat | 0.55 | 0.55 |
| Milk Solds nonfat | 9 | 9 |
| Whey powder | 2.5 | 2.4 |
| Liq Sucrose (67% t.s.) | 20 | 13.5 |
| Corn syrup (80% t.s.) | 6.25 | 5 |
| Polydextrose | 5.5 | 5.3 |
| Stabilizer Gum Emulsifier | | |
| Blend (ex Danisco) | 0.37 | 0.37 |
| Stabilizer (Avicel) | 0.35 | 0.35 |
| Star Vite A | 0.003 | 0.003 |
| steryl esters | 2.45 | 2.45 |
| Water | 53 | |

The procedure is as follows:

1. Draw water into liquifier. Water up to 100° F. should be used when utilizing the cold batching method for non-viscous mixes.

2. Blend liquid sucrose and corn syrup.

3. Add blend of stabilizers slowly (10#/minute). Allow to blend until stabilizers are hydrated.

4. Add whey followed by Polydextrose.

5. Add milk source (fresh milk or condensed skim milk are preferred sources) to liquifier or blend tank to dilute mixture.

6. Add Star Vite A.

7. Add Steryl Esters. Then add cream and agitate for 5 minutes before pasteurizing.

8. Pasteurize and homogenize at standard temperatures and pressures.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1. A frozen confection comprising a cholesterol lowering plant sterol or stanol, and/or esters thereof, milk fat, and a protein source.

2. The frozen confection according to claim 1 wherein the protein source is powdered diary protein.

3. The frozen confection according to claim 2 wherein the powdered dairy protein is whey protein.

4. The frozen confection according to claim 1 which is a reduced triglyceride ice cream.

5. The frozen confection according to claim 1 which is selected from the group consisting of ice cream, sherbet, sorbet and water ice.

6. The frozen confection according to claim 1 further comprising 1-20 wt % polydextrose.

7. The frozen confection according to claim 1 wherein said plant sterol and/or stanol ester is present at from 0.5 to 15 wt %.

8. The frozen confection according to claim 7 comprising from 0.2 to 5 wt % milk fat.

9. The frozen confection according to claim 8 comprising from 0 to 3 wt % milk fat.

10. The frozen confection according to claim 1 comprising 0.5 to 10 wt % powdered protein.

11. The frozen confection according to claim 10 further comprising from 1 to 5 wt % powdered dairy protein.

12. The frozen confection according to claim 1 further comprising a stabilizer selected from the group consisting of microcrystalline cellulose, locust bean gum, carrageenan, guar gum, xanthan gum, and mixtures thereof.

13. The frozen confection according to claim 1 further comprising an emulsifier.

14. A frozen confection comprising a cholesterol lowering plant sterol or stanol, and/or esters thereof and up to 5 wt % triglycerides.

15. The frozen confection according to claim 14, further comprising a powdered protein source.

16. The frozen confection according to claim 15 wherein the powdered protein source is powdered diary protein.

17. The frozen confection according to claim 16 which is a reduced triglyceride ice cream.

18. The frozen confection according to claim 16 which is selected from the group consisting of reduced fat ice cream, sherbet, sorbet and water ice.

19. The frozen confection according to claim 14 further comprising 1-20 wt % polydextrose.

20. The frozen confection according to claim 14 wherein said plant sterol and/or stanol ester is present at from 0.5 to 15 wt %.

21. The frozen confection according to claim 14 comprising fat at from 0.2 to 5 wt %.

22. The frozen confection according to claim 21 wherein the fat comprises milk fat

23. The frozen confection according to claim 14 comprising 0.5 to 10 wt % powdered protein.

24. The frozen confection according to claim 14 further comprising a stabilizer selected from the group consisting of microcrystalline cellulose, locust bean gum, carrageenan, guar gum, xanthan gum, and mixtures thereof.

25. The frozen confection according to claim 1 further comprising an emulsifier.

26. The frozen confection according to claim 14 comprising essentially no triglycerides.

27. The frozen confection according to claim 14 further comprising soy protein.

28. The frozen confection according to claim 15 wherein said powdered protein source comprises soy protein.
